(19) United States
(12) Patent Application Publication
(10) Pub. No.: US 2019/0074516 A1
(43) Pub. Date: Mar. 7, 2019

(54) ELECTRODE SLURRY AND ELECTRODE AND LITHIUM SECONDARY BATTERY INCLUDING THE SAME

(71) Applicants: Hyundai Motor Company, Seoul (KR); Kia Motors Corporation, Seoul (KR)

(72) Inventors: Seung Min Oh, Incheon (KR); Yoon Sung Lee, Suwon (KR); Ki Seok Koh, Suwon (KR); Yeol Mae Yeo, Anseong (KR)

(21) Appl. No.: 15/831,137

(22) Filed: Dec. 4, 2017

(30) Foreign Application Priority Data
Sep. 7, 2017 (KR) 10-2017-0114585

(51) Int. Cl. H01M 4/62; H01M 10/0525; H01M 4/583; H01M 4/38

(52) U.S. Cl. CPC H01M 4/622; H01M 10/0525; H01M 4/626; H01M 4/386; H01M 4/625; H01M 4/583

(57) ABSTRACT

Provided are electrode slurry including (A) an electrode active material, (B) a conductive material, and (C) a binder containing a cellulose compound, styrene-butadiene rubber and lithium polyacrylic acid at the same time, and an electrode and a lithium secondary battery including the slurry.

### CROSS-REFERENCE TO RELATED APPLICATION

This application claims under 35 U.S.C. § 119(a) the benefit of Korean Patent Application No. 10-2017-0114585 filed Sep. 7, 2017, the entire contents of which are incorporated herein by reference.

### TECHNICAL FIELD

The present invention relates to a composition for electrode slurry, an electrode including the same, and a lithium secondary battery including the electrode. The composition may include (A) an electrode active material, (B) a conductive material, and (C) a binder including a cellulose compound, styrene-butadiene rubber and lithium polyacrylic acid.

### BACKGROUND

An automobile industry using electric energy other than fossil fuel has been diversified, and a lithium secondary battery has been widely used in effort to overcome environmental pollution. For example, in order to improve the mileage, the high energy density of the battery is currently the most important issue and in order to achieve the high energy density, the energy density of the material used needs to be improved.

Currently, batteries using Ni, Co, Mn-based or Ni, Co, Al-based cathode materials and a graphite anode have been developed, but due to limit of energy density, development of new electrode materials enough to replace the materials has been needed.

For example, a rapid shift in the development of technology to metals, metal oxides, or metal complexes of silicon as well as a cost reduction of carbons as an anode material have been achieved. Unlike a cathode material having a small specific capacity, as an anode material, high-capacity materials such as silicon (Si) or tin (Sn) may be applied. For example, silicon has a high capacity of more than 4000 mAh/g and has 10 times greater energy density than an existing graphite anode material having a specific capacity of 360 mAh/g. Nevertheless, silicon may not be applied as an electrode active material because, for example, the volume change is 400% during the secondary battery reaction, and thus the lifespan of the battery may be short.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention may provide a composition for an electrode slurry capable of solving problems that performance of a secondary battery is deteriorated and a lifespan is shortened during repeated charging and discharging.

In addition, the present invention may provide an electrode and a secondary battery including the composition for the electrode slurry.

In one aspect, provided is a composition for an electrode slurry. The composition may include: (A) an electrode active material, (B) a conductive material, and (C) a binder. Preferably, the (C) binder, may include: (C-1) a cellulose compound comprising carboxymethylcellulose (CMC) or an alkali metal salt thereof; (C-2) styrene-butadiene rubber (SBR); and (C-3) lithium polyacrylic acid (LiPAA).

The term “electrode active material” as used herein refers to a material that may generate or receive electrons, or alternatively, a material that may oxidized or reduced, in a battery or cell. For example, an anode active material may generate electrons and a cathode active material may receive electrons, or an anode active material may be oxidized and a cathode active material may be reduced, such that an electric current may be generated between the cathode and the anode.

The term “binder” as used herein refers to a resin or polymeric compound that preferably may function as an adhesive material.

The binder may suitably include: (C-1) an amount of about 0.001 to 10 wt % of the cellulose compound; (C-2) an amount of about 0.001 to 10 wt % of the styrene-butadiene rubber (SBR); and/or (C-3) an amount of about 0.001 to 10 wt % of the lithium polyacrylic acid (LiPAA), all the wt % based on the total weight of the binder. Preferably, the binder may include: (C-1) an amount of about 0.01 to 5 wt % of the cellulose compound; (C-2) an amount of about 0.01 to 5 wt % of the styrene-butadiene rubber (SBR); and (C-3) an amount of about 0.01 to 5 wt % of the lithium polyacrylic acid (LiPAA), all the wt % based on the total weight of the binder.

In other aspect, the composition may consist essentially of, essentially consist of, or consist of the components as described above. For instance, the composition may consist essentially of, essentially consist of, or consist of: (A) the electrode active material, (B) the conductive material, and (C) the binder, wherein the (C) binder comprises: (C-1) a cellulose compound comprising carboxymethylcellulose (CMC) or an alkali metal salt thereof; (C-2) styrene-butadiene rubber (SBR); and (C-3) lithium polyacrylic acid (LiPAA).

The electrode active material may suitably be selected from the group consisting of graphite, silicon, and a graphite-silicon composite material. The electrode active material may suitably be a graphite-silicon composite material.

The term “conductive material” as used herein refers to a material where electrons may be transferred or transmitted. Typically preferred conductive materials includes carbon, metal, silicone or the like that allows or provides an electrical current in one or more directions.

The conductive material may suitably be at least one selected from the group consisting of natural graphite, artificial graphite, carbon black, acetylene black, Ketjen black, channel black, furnace black, lamp black, summer black, carbon nanotube, fullerene, carbon fiber, metallic fiber, fluorine carbon, aluminum, nickel powder, zinc oxide, potassium titanate, titanium dioxide, and polyphenylene derivatives.

Also provided is an electrode including the composition as described herein. The composition may be applied by a current collector.

Further provided is a lithium secondary battery including the electrode as described herein.

The electrode slurry according to the present invention may prevent deterioration of performance of a secondary battery and reduction of a lifespan during repeated charging and discharging. Particularly, volume expansion of a silicon active material may be efficiently controlled and irreversible reaction may be suppressed.

The electrode slurry comprising the composition as described herein according to the present invention may have an effect of not only inducing uniform dispersion of graphite particles and silicon particles in a graphite-silicon composite material included as an electrode active material, but also enhancing the adhesion between the particles.

In addition, the electrode slurry may have an effect of ensuring excellent output characteristics, lifespan characteristics, and electrode bonding stability in a secondary battery including an anode active material of graphite, silicon or a graphite-silicon composite material.

In another aspect, the present invention provides an all solid state battery including a cathode substrate 10, a cathode portion 20, a solid electrolyte layer 30, an anode portion 40 and an anode substrate. The cathode portion 20 may include a cathode active material, a first solid electrolyte, a conductive material and a binder. Preferably, the anode portion 40 may be configured by a first anode portion 41 having a structure of pores 43 and a second anode portion 42 having metal foil, and the first anode portion 41 may include a second solid electrolyte, a conductive material and a binder.

In another aspect, the present invention provides a manufacturing method of an all solid state battery including: (a) forming a cathode portion 20 by applying and drying a cathode slurry including a cathode active material, a first solid electrolyte, a conductive material and a binder on the cathode substrate 10; (b) forming a solid electrolyte layer 30 by applying and drying a solid electrolyte on the cathode portion 20; (c) forming a first anode portion 41 by applying and drying anode slurry including a second solid electrolyte, a conductive material and a binder on the solid electrolyte layer 30; (d) forming a second anode portion 42 having metal foil on the first anode portion 41; and (e) forming and then compressing an anode substrate 50 on the second anode portion 42.

Still further provided herein is a vehicle that includes the lithium secondary battery or the all-solid batter as described herein.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 illustrates an addition effect of lithium polyacrylic acid (LiPAA) in an exemplary electrode slurry according to an exemplary embodiment of the present invention;

FIG. 2 is a graph of comparing addition effects of lithium polyacrylic acid (LiPAA) in an exemplary graphite secondary battery electrode according to an exemplary embodiment of the present invention;

FIG. 3 is a graph of comparing effects depending on a change in adding amount of lithium polyacrylic acid (LiPAA) in an exemplary graphite-silicon secondary battery electrode according to an exemplary embodiment of the present invention;

FIG. 4 is a graph of comparing addition effects of lithium polyacrylic acid (LiPAA) or polyacrylic acid (PAA) in an exemplary silicon electrode according to an exemplary embodiment of the present invention; and

FIG. 5 is a graph of comparing effects depending on changes in the content of natural graphite (N.G.) or artificial graphite (A.G.) as an active material and the loading amount of a graphite-silicon anode in an exemplary graphite-silicon secondary battery electrode according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, regions, integers, steps, operations, elements and/or components but do not preclude the presence or addition of one or more other features, regions, integers, steps, operations, elements, components, and/or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various embodiments of the present invention, examples of which are illustrated in the accompanying drawings and described below. While the invention will be described in conjunction with various exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention may have various modifications and various embodiments and specific embodiments will be illustrated in the accompanying drawings described in detail in the detailed description. However, it should be understood that this does not limit the present invention to specific embodiments, and it should be understood that the present invention covers all the modifications, equivalents and replacements included within the idea and technical scope of the present invention.

In the related art, an electrode slurry includes (A) an electrode active material, (B) a conductive material, and (C) a binder. In order to apply a graphite-silicon composite material as an anode active material for implementing a high-capacity secondary battery, it is necessary to induce uniform dispersion between graphite particles and silicon particles and to maintain excellent adhesion between the particles, and particularly, a technique for efficiently controlling the volume expansion of silicon during charging and discharging is required.

In one aspect, provided is a composition for an electrode slurry capable of satisfying such a demand. The composition for the electrode slurry of the present invention may include: (A) an electrode active material, (B) a conductive material, and (C) a binder in an aqueous solution. In addition, the electrode slurry may further include an electrochemically active compound. The electrochemically active compound may include at least one of graphite; titanate; lithium metal oxides such as lithium manganese oxide (LMO), lithium nickel cobalt aluminum oxide (Li-NCA), lithium cobalt oxide (LCO), lithium nickel cobalt manganese oxide (LNCM), and lithium iron phosphate (LFP); silicon compounds such as Si, SiOx, Si-M, and Si-M-C (in this case, M is a transition metal element, and x is a variable for controlling the oxidation number); tin compounds such as Sn, SnOx, Sn-M, and Sn-M-C (in this case, M is a transition metal element, and x is a variable for controlling the oxidation number); and other metal oxides or other materials known in the art as well as mixtures thereof. In addition, the electrode slurry may be used as a positive electrode, a negative electrode, or a cathode and an anode.

Particularly, the electrode slurry of the present invention may include (C-1) a cellulose compound including carboxymethyl cellulose (CMC) or alkali metal salts thereof, (C-2) styrene-butadiene rubber (SBR) and (C-3) lithium polyacrylic acid (LiPAA) at the same time as the (C) binder in the slurry including (A) the electrode active material, (B) the conductive material, and (C) the binder.

The electrode slurry according to the present invention will be described below in more detail.

(A) Electrode Active Material

The electrode slurry of the present invention may include the electrode active material selected from the group consisting of graphite, silicon and a graphite-silicon composite material. The graphite may suitably be natural graphite (N.G.), artificial graphite (A.G.) or a mixture thereof. When the natural graphite and the artificial graphite are simultaneously contained as the electrode active material, an advantageous effect on the volume expansion of silicon and the electrode stability may be expected. Preferably, the artificial graphite may be advantageous for stabilizing the lifespan characteristic of the anode. The silicon may suitably include silicon (Si), silicon oxide (SiOx), or an alloy (Si-M alloy) of silicon and another metal. The graphite-silicon composite material may be typically used in a secondary battery field, and for example, the graphite-silicon composite material may be fabricated by simply mixing nano-sized silicon particles with graphite particles, or by mixing, coating, doping, or alloying carbon and/or other metal powders with the mixture of the silicon particles and the graphite particles. In the graphite-silicon composite material, the silicon particles and the graphite particles may be mixed at a weight ratio of about 95:5 to 1:99. Preferably, the graphite-silicon composite material may suitably include a composite material of natural graphite (1-x-y)-artificial graphite (x)-silicon (y), wherein, 0<x<1.0 and 0<y<1.0. Further, in the present invention, a composition and a fabrication method of the graphite-silicon composite material are not particularly limited.

The electrode active material may be contained in a range of about 60 to 97 wt %, or particularly of about 80 to 97 wt %, based on the total weight of the electrode slurry.

(B) Conductive Material

The conductive material may be contained in the composition of the electrode slurry of the present invention. The conductive material may not be particularly limited as long as the conductive material has conductivity without causing side reactions with other elements of the battery. The conductive material may contain at least one selected from the group consisting of, for example, natural graphite, artificial graphite, carbon black, acetylene black, Ketjen black, channel black, furnace black, lamp black, summer black, carbon nanotube, fullerene, carbon fiber, metallic fiber, fluorine carbon, aluminum, nickel powder, zinc oxide, potassium titanate, titanium dioxide, and polyphenylene derivatives. For instance, carbon black may be used as the conductive material, but the kind of conductive material applied to the present invention is not limited to carbon black.

The conductive material may be contained in a range of about 0.05 to 5.0 wt %, or particularly of about 1.0 to 3.0 wt %, based on the total weight of the electrode slurry.

(C) Binder

The electrode slurry of the present invention may include a cellulose compound that may include carboxymethylcellulose (CMC) or an alkali metal salt thereof, styrene-butadiene rubber (SBR) and lithium polyacrylic acid (LiPAA) as the binder.

The cellulose compound may be a water-soluble polymer additive, and may be a component included for improving a solid content increasing effect and the phase stability. Further, the graphite-silicon composite material may be used as the electrode active material. Particularly, in order to uniformly disperse graphite contained as the electrode active material in an aqueous solution, the cellulose compound may be included. The cellulose compound may suitably include, for example, carboxymethylcellulose (CMC), carboxymethylcellulose sodium salt (CMCNa), carboxymethylcellulose lithium salt (CMCLi), and the like. The molecular weight of the cellulose compound may be determined by a length of the polymer chain. Preferably, the cellulose compound having a weight average molecular weight (Mw) in the range of about 600,000 to 1,200,000, or particularly of about 800,000 to 1,200,000 may be used. When the molecular weight of the cellulose compound is less than the predetermined range, for example, less than about 800,000, aggregation of the electrode slurry may occur, and when the molecular weight is greater than the predetermined range, for example, greater than about 1,200,000, the cellulose compound may not be dissolved in the electrode slurry to increase the solid content.

The cellulose compound may be contained in a range of about 0.001 to 10 wt %, or particularly of about 0.03 to 5 wt %, based on the total weight of the electrode slurry. When the content of the cellulose compound is less than about 0.001 wt %, effects of improving the binding strength of the electrode and the phase stability of the slurry may be obtained, and when the content is greater than about 10 wt %, the solid concentration of the slurry may be reduced, and as a result, a channel in which a current may flow in the electrode may not be locally formed to increase the resistance inside the battery or the current concentration may occur to inhibit the performance and stability of the battery.

The styrene-butadiene rubber (SBR) may be a rubber-based binder and may be included as an adhesive/bonding type binder for bonding with the electrode active material, the conductive material, and the current collector.

The styrene-butadiene rubber (SBR) may be contained in a range of about 0.001 to 10 wt %, or particularly of about 0.03 to 5 wt %, based on the total weight of the electrode slurry. When the content of the styrene-butadiene rubber (SBR) is less than about 0.001 wt %, adhesion improvement effect may not be obtained, and when the content is greater than about 10 wt %, energy density of the electrode rapidly may decrease or the hardening of the slurry may occur, and thus, the slurry may not be sufficiently mixed.

In the electrode slurry of the present invention, the cellulose compound and the styrene-butadiene rubber (SBR) may be simultaneously contained as a required component. The total content of the cellulose compound and the styrene-butadiene rubber (SBR) may be contained in a range of about 0.02 to 10 wt %, or particularly of about 0.1 to 6 wt %, based on the total weight of the electrode slurry.

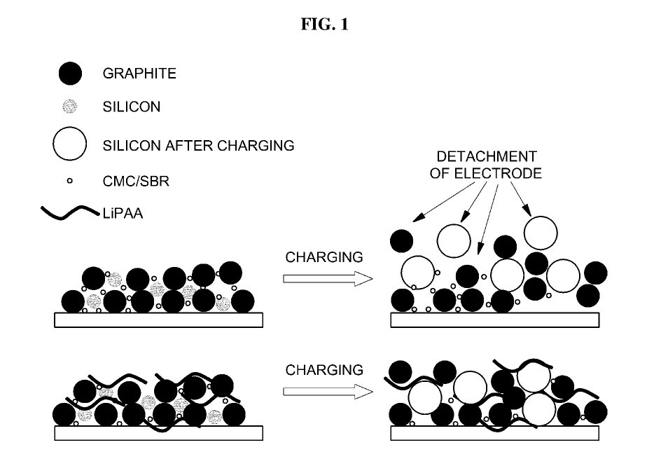

The lithium polyacrylic acid (LiPAA) may be a polymer in which lithium ion may be substituted for polyacrylic acid, and may be contained for improving the adhesion strength for the electrode active material with the cellulose compound and the conductive material and efficiently controlling the volume expansion of the silicon contained in the electrode active material. FIG. 1 illustrates an addition effect of lithium polyacrylic acid (LiPAA) in an exemplary slurry. As shown in FIG. 1, lithium polyacrylic acid (LiPAA) as the binder component may be added to the graphite-silicon composite anode active material to induce uniform dispersion and enhancement of adhesion of graphite particles and silicon particles and control the volume expansion of silicon.

The lithium polyacrylic acid may be prepared by stirring polyacrylic acid and lithium hydroxide (LiOH) at room temperature. In this case, polyacrylic acid may have a weight average molecular weight in the range of about 130,000 to 3,000,000, or particularly of about 450,000 to 250,000. The lithium compound may be added in a range of about 0.1 to 1 mol % based on the molar amount of the polyacrylic acid.

The lithium polyacrylic acid (LiPAA) may be contained in a range of about 0.001 to 10 wt %, or particularly of about 0.03 to 5 wt %, based on the total weight of the electrode slurry. When the content of lithium polyacrylic acid (LiPAA) is less than about 0.001 wt %, the adhesion improving effect and the silicon volume increase suppressing effect may not be obtained, and when the content is greater than about 10 wt %, the energy density of the electrode may be rapidly decreased and the lifespan of the battery may be rapidly decreased, and thus curl of the electrode may be severely generated or the electrode may be hardened and easily broken.

The binder described above may be contained in a range of about 0.5 to 30 wt %, or particularly of about 1 to 10 wt %, based on the total weight of the electrode slurry.

Meanwhile, the present invention includes an electrode or a secondary battery including the slurry described above.

A fabrication method of the electrode may include fabricating slurry by mixing an electrode active material, a conductive material, and a binder in an aqueous solution, coating or laminating the slurry on a current collector, and fabricating the electrode by drying the slurry. The fabrication method of the electrode may further include adding a non-aqueous electrolyte.

The secondary battery may be fabricated by inserting the electrode fabricated by the fabrication method into an electrochemical cell.

As described above, the present invention will be described in more detail based on the following Examples and the present invention is not limited thereto.

### EXAMPLES

The following examples illustrate the invention and are not intended to limit the same.

### Example 1. Graphite-Silicon Secondary Battery Electrode

(1) Fabrication of Graphite-Silicon Electrode Slurry

Natural graphite, artificial graphite and silicon were used as an active material, and carbon black was used as a conductive material. A graphite-silicon composite material was prepared by mixing natural graphite, artificial graphite, and silicon powder at a weight ratio of 61:26:13. Carboxymethylcellulose (CMC) and styrene-butadiene rubber (SBR) were dispersed in water, and then lithium polyacrylic acid (LiPAA) was further dispersed to fabricate an aqueous binder. In addition, the active material, the carbon black and the binder were mixed with composition ratios illustrated in Table 1 below to fabricate final slurry.

(2) Fabrication of Secondary Battery Electrode

The electrode slurry fabricated above was applied on copper foil as a current collector by a Comma coater method so as to have a thickness of 80 μm. The electrode slurry was applied and then dried at a temperature of 80° C. to fabricate the secondary battery electrode.

TABLE 1

| | | | | | | Characteristics of graphite secondary | | |
|---|---|---|---|---|---|---|---|---|
| | | | | | | battery electrode | | |
| | | | | | | | Lifespan | Electrode |
| | Composition of slurry (wt %) | | | | | Specific | characteristic | expansion |
| | Active | Carbon | Binder | | | capacity | (50 cycles, room | (after first |
| Classification | material | black | CMC | SBR | LiPAA | (mAh/g) | temperature) | charging) |
| Example 1-1 | 93 | 2 | 1.5 | 1.5 | 2.0 | 500 | 97.0% | 29.0% |
| Example 1-2 | 93 | 2 | 1.5 | 1.5 | 1.0 | 500 | 90.0% | 35.0% |
| Example 1-3 | 92 | 2 | 1.5 | 1.5 | 3.0 | 500 | 94.5% | 31.0% |
| Example 1-4 | 91 | 2 | 1.5 | 1.5 | 4.0 | 500 | 94.3% | 28.0% |
| Example 1-5 | 90 | 2 | 1.5 | 1.5 | 5.0 | 500 | 95.7% | 34.0% |
| Comparative | 94 | 3 | 1.5 | 1.5 | 0 | 500 | 70.9% | 47.0% |
| Example 1-1 | | | | | | | | |
| Comparative | 93 | 2 | 2.5 | 2.5 | 0 | 500 | 80.0% | 42.0% |
| Example 1-2 | | | | | | | | |
| Comparative | 91 | 2 | 0 | 0 | 7.0 | 500 | 90.2% | 34.0% |
| Example 1-3 | | | | | | | | |

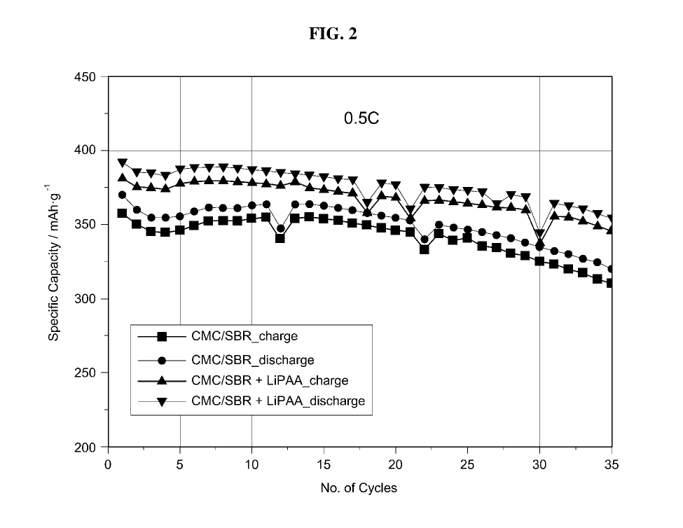

FIG. 2 is a graph of comparing addition effects of lithium polyacrylic acid (LiPAA) as a binder component in an exemplary graphite-silicon secondary battery electrode. Particularly, FIG. 2 illustrates a result of measuring specific capacities of graphite electrodes fabricated in Example 1-1 and Comparative Example 1-1 during charging and discharging of 35 cycles. As shown in FIG. 2, i when lithium polyacrylic acid (LiPAA) was added as a binder component, the 0.5 C specific capacity was increased and the lifespan characteristic was also extended.

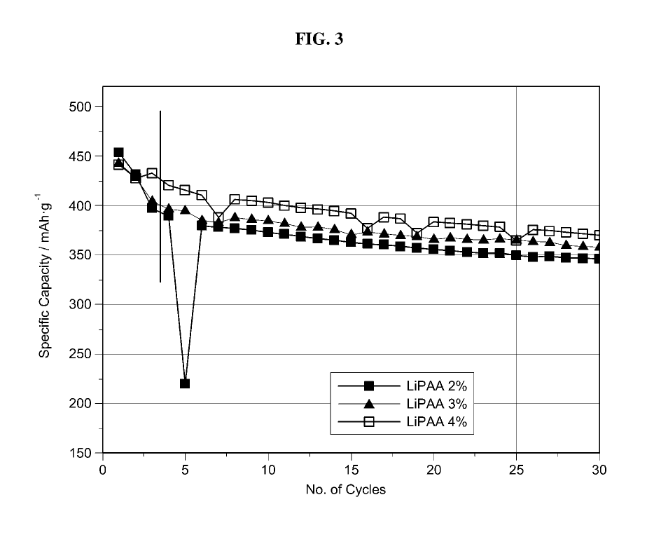

FIG. 3 is a graph of comparing effects depending on an increase in the content of lithium polyacrylic acid (LiPAA) in an exemplary graphite-silicon secondary battery electrode. FIG. 3 illustrates a result illustrating 0.5 C specific capacities during charging and discharging after stabilizing the graphite electrodes fabricated in Examples 1-1, 1-3, and 1-4 at 0.1 C 3 cycles. As shown in FIG. 3, the lifespan characteristics were improved by increasing the content of lithium polyacrylic acid (LiPAA).

### Example 2. Silicon Secondary Battery Electrode

(1) Fabrication of Silicon Electrode Slurry

Silicon was used as an active material and carbon black was used as a conductive material. An amount of 1.5 wt % of carboxymethylcellulose (CMC) and an amount of 1.5 wt % of styrene-butadiene rubber (SBR) were dispersed in water, and then an amount of 2 wt % of lithium polyacrylic acid (LiPAA) was further dispersed to fabricate an aqueous binder. In addition, an amount of 92.0 wt % of the fabricated active material, an amount of 3.0 wt % of the carbon black, and an amount of 5.0 wt % of the binder were mixed to fabricate final slurry.

(2) Fabrication of Secondary Battery Electrode

The electrode slurry fabricated above was applied on copper foil as a current collector by a Comma coater method so as to have a thickness of 80 μm. The electrode slurry was applied and then dried at a temperature of 80° C. to fabricate the secondary battery electrode.

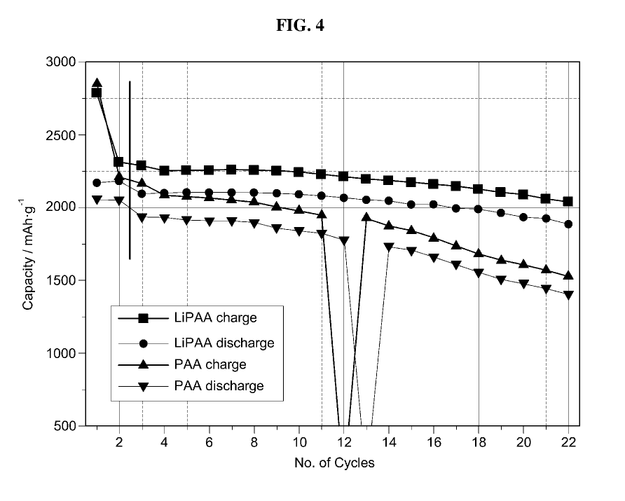

FIG. 4 is a graph of comparing addition effects of lithium polyacrylic acid (LiPAA) or polyacrylic acid (PAA) as binder components in an exemplary silicon secondary battery electrode. In Comparative Example, a silicon secondary battery electrode was fabricated by Example 3, and an amount of 2 wt % of polyacrylic acid (PAA) instead of lithium polyacrylic acid (LiPAA) as a binder component was contained to fabricate the silicon secondary battery electrode.

As shown in FIG. 4, the specific capacity of the silicon electrode was very high. Accordingly, in the silicon electrode added with lithium polyacrylic acid (LiPAA) as the binder component, reduction of the specific capacity was substantially reduced even after repeated charging and discharging, while the specific capacity of the silicon electrode added with polyacrylic acid (PAA) was rapidly decreased.

### Example 3. Graphite-Silicon Secondary Battery Electrode

(1) Fabrication of Graphite-Silicon Composite Electrode Slurry

A graphite-silicon composite material was used as an active material. The graphite-silicon composite material was fabricated by changing a mixing ratio of graphite (natural graphite (N.G.) or artificial graphite (A.G.)) and silicon powder as illustrated in Table 2 below. Carbon black was used as a conductive material. Carboxymethylcellulose (CMC) and styrene-butadiene rubber (SBR) were dispersed in water, and then lithium polyacrylic acid (LiPAA) was further dispersed to fabricate an aqueous binder. In addition, an amount of 92.0 wt % of the fabricated active material, an amount of 3.0 wt % of the carbon black, and an amount of 5.0 wt % of the binder were mixed to fabricate final slurry.

(2) Fabrication of Secondary Battery Electrode

The electrode slurry fabricated above was applied on copper foil as a current collector by a Comma coater method so as to have a thickness of 80 μm. The electrode slurry was applied and then dried at a temperature of 80° C. to fabricate the secondary battery electrode. In this case, an electrode loading amount in Examples 3-1 and 3-2 was 6.0 mg/cm² and an electrode loading amount in Examples 3-3 to 3-6 was 10.0 mg/cm².

TABLE 2

| | | | | | | 0.1 C |
|---|---|---|---|---|---|---|
| | Electrode active | | Composition | | | Specific |
| | material (wt %) | | of binder (wt %) | | | capacity |
| Classification | Graphite | Silicon | CMC | SBR | LiPAA | (mAh/g) |
| Example 3-1 | N.G. (95) | 5 | 1.0 | 2.0 | 2.0 | 430 |
| Example 3-2 | N.G. (91) | 9 | 1.0 | 2.0 | 2.0 | 430 |
| Example 3-3 | N.G. (95) | 5 | 1.0 | 2.0 | 2.0 | 430 |
| Example 3-4 | N.G. (91) | 9 | 1.0 | 2.0 | 2.0 | 430 |
| Example 3-5 | A.G. (95) | 5 | 1.0 | 2.0 | 2.0 | 430 |
| Example 3-6 | A.G. (91) | 9 | 1.0 | 2.0 | 2.0 | 430 |

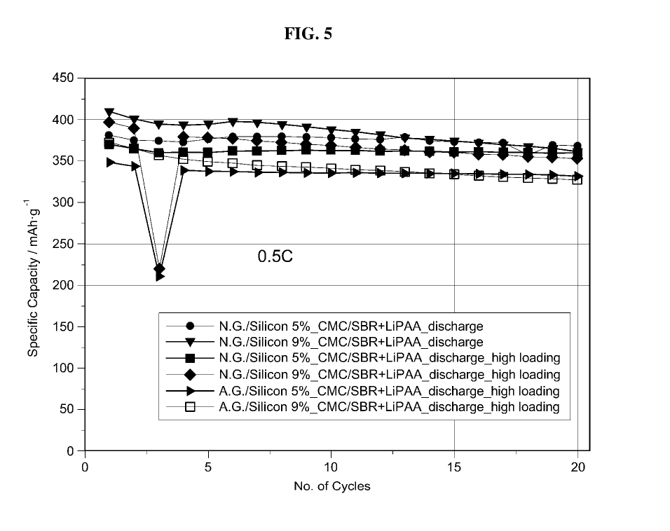

In FIG. 5, the result of Table 2 above was illustrated by a graph. As shown in FIG. 5, although the silicon content was increased, the lifespan characteristic may be substantially improved by using the polyacrylic acid (LiPAA) binder. When comparing Examples 3-1 and 3-3 or 3-2 and 3-4, the lifespan characteristic was maintained even if the loading amount per unit electrode area was increased. In addition, when comparing Examples 3-3 and 3-4 with Examples 3-5 and 3-6, even when the graphite material was changed from natural graphite to artificial graphite, the excellent lifespan characteristic was maintained.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A composition for an electrode slurry, comprising:
(A) an electrode active material,
(B) a conductive material, and
(C) a binder,
wherein the (C) binder comprises:
(C-1) a cellulose compound comprising carboxymethylcellulose (CMC) or an alkali metal salt thereof;
(C-2) styrene-butadiene rubber (SBR); and
(C-3) lithium polyacrylic acid (LiPAA).

2. The composition of claim 1, consisting essentially of:
(A) the electrode active material,
(B) the conductive material, and
(C) the binder,
wherein the (C) binder comprises:
(C-1) a cellulose compound comprising carboxymethylcellulose (CMC) or an alkali metal salt thereof;
(C-2) styrene-butadiene rubber (SBR); and
(C-3) lithium polyacrylic acid (LiPAA).

3. The composition of claim 1, consisting of:
(A) the electrode active material,
(B) the conductive material, and
(C) the binder,
wherein the (C) binder comprises:
(C-1) a cellulose compound comprising carboxymethylcellulose (CMC) or an alkali metal salt thereof;
(C-2) styrene-butadiene rubber (SBR); and
(C-3) lithium polyacrylic acid (LiPAA).

4. The composition of claim 1, wherein the binder comprises:
(C-1) an amount of about 0.001 to 10 wt % of the cellulose compound;
(C-2) an amount of about 0.001 to 10 wt % of the styrene-butadiene rubber (SBR); and
(C-3) an amount of about 0.001 to 10 wt % of the lithium polyacrylic acid (LiPAA),
all the wt % based on the total weight of the binder.

5. The composition of claim 1, wherein the binder comprises:
(C-1) an amount of about 0.01 to 5 wt % of the cellulose compound;
(C-2) an amount of about 0.01 to 5 wt % of the styrene-butadiene rubber (SBR); and
(C-3) an amount of about 0.01 to 5 wt % of the lithium polyacrylic acid (LiPAA),
all the wt % based on the total weight of the binder.

6. The composition of claim 1, wherein the electrode active material is selected from the group consisting of graphite, silicon, and a graphite-silicon composite material.

7. The composition of claim 1, wherein the electrode active material is a graphite-silicon composite material.

8. The composition of claim 1, wherein the conductive material is at least one selected from the group consisting of natural graphite, artificial graphite, carbon black, acetylene black, Ketjen black, channel black, furnace black, lamp black, summer black, carbon nanotube, fullerene, carbon fiber, metallic fiber, fluorine carbon, aluminum, nickel powder, zinc oxide, potassium titanate, titanium dioxide, and polyphenylene derivatives.

9. An electrode comprising a composition of claim 1, wherein the composition is applied by a current collector.

10. A lithium secondary battery comprising an electrode of claim 9.

11. A vehicle comprising a lithium secondary battery of claim 10.
